(19) United States
(12) Patent Application Publication
(10) Pub. No.: US 2013/0253250 A1
(43) Pub. Date: Sep. 26, 2013

(54) Method for High-Pressure Hydrocarbon Gas Mixture Purification and Plant for Implementing Thereof

(71) Applicant: Closed Joint-Stock Company "GRASYS", Stupino (RU)

(72) Inventors: Mikhail Alexandrovich GULYANSKY, Moscow (RU); Nicolay Leonidovich DOKUCHAEV, Balashikha (RU); Alexander Alexandrovich KOTENKO, Moscow (RU); Eugeny Gennadievich KRASHENINNIKOV, Khimki (RU); Sergey Vladimirovich POTEKHIN, Khimki (RU); Mikhail Mikhailovich CHELYAK, Moscow (RU); Marina Kadyrovna TEREKHOVA, Moscow (RU)

(21) Appl. No.: 13/897,404

(22) Filed: May 18, 2013

Related U.S. Application Data
(63) Continuation of application No. PCT/RU2011/000888, filed on Nov. 11, 2011.

(30) Foreign Application Priority Data
Nov. 18, 2010 (RU) 2010146784
Nov. 18, 2010 (RU) 2010146786
Jan. 28, 2011 (RU) 2011103090
Jan. 28, 2011 (RU) 2011103091
Apr. 28, 2011 (RU) 2011116894
Apr. 28, 2011 (RU) 2011116895
May 17, 2011 (RU) 2011119725
Jul. 6, 2011 (RU) 2011127529
Jul. 6, 2011 (RU) 2011127531

(51) Int. Cl. B01D 53/22

(52) U.S. Cl. CPC B01D 53/225
USPC 585/818; 96/10; 96/9; 96/8

(57) ABSTRACT

A method is proposed for operating a plant for purifying a high-pressure gas mixture from easily permeating components, which plant comprises membrane gas separating units having a high-pressure chamber and a low-pressure chamber with a selectively permeable membrane therebetween, in which method the low-pressure chamber of at least one membrane gas separating unit is continuously flushed with purified gas mixture (semi-finished product or product), wherein the pressure difference between the aforementioned chambers of the membrane gas separating unit and, likewise, the flow rate of the purified gas mixture used for flushing are maintained so that the amount of each easily permeating component in the product does not exceed the desired values. The proposed method makes it possible to purify a raw material from one or more easily permeating components simultaneously, increase purification efficiency, and provide the possibility of using raw material with a higher content of easily permeating components.

### RELATED APPLICATIONS

This Application is a Continuation application of International Application PCT/RU2011/000888, filed on Nov. 11, 2011, which in turn claims priority to Russian Patent Applications No. RU 2010146784, filed Nov. 18, 2010, RU 2010146786, filed Nov. 18, 2010, RU 2011103090, filed Jan. 28, 2011, RU 2011103091, filed Jan. 28, 2011, RU 2011116894, filed Apr. 28, 2011, RU 2011116895, filed Apr. 28, 2011, RU 2011119725, filed May 17, 2011, RU 2011127531, filed Jul. 6, 2011, RU 2011127529, filed Jul. 6, 2011 all of which are incorporated herein by reference in their entirety.

### FIELD OF THE INVENTION

The inventions group relates to the field of gas mixtures separation by selectively permeable membranes (SPMs) and can be applied in gas, oil, chemical and other industrial fields.

### BACKGROUND OF THE INVENTION

Majority of tasks on purification of hydrocarbon gas mixtures require simultaneous treatment of a raw material as the HPGM (high-pressure gas mixture) from several components simultaneously, herewith the purification process as a rule has to be carried out without significant pressure loss of the HPGM and with minimum raw material losses (i.e. with maximum product yield, the term product refers to the raw material purified to set parameters).

For example, natural gas supplied to the main pipelines must correspond with the industrial standards related in this technical field on the limit contents of several components namely, the content of hydrogen sulphide, merkaptans, CO2, water vapours and condensing hydrocarbons. For the moderate climate the limiting mass concentration of hydrogen sulphide in gas mixture per OST 51.40-93 must be no more than 7 mg/m³, merkaptans must be no more than 16 mg/m³, molar part of CO2 must be no more than 2.5% mole, hydrocarbon dew point must be no higher than minus 2° C., water dew point must be no higher than minus 10° C. The requirements to the limiting contents of water vapours and condensing hydrocarbons are more stringent for regions with cold climate with the same requirements to hydrogen sulphide, merkaptans and CO2: hydrocarbon dew point must be no higher than minus 5.0° C. in summer and minus 10.0° C. in winter, dew point for water must be minus 14° C. in summer and minus 20.0 ° C. in winter.

Besides high yield of the finished product the gas separation processes must provide as low energy consumption as possible per product unit (the specific energy consumption). Thus it is necessary to minimize the energy consumption at the compressors' actuation (active equipment), heat-exchange (heating and cooling), and also increase the productivity of the passive equipment, first of all the square area unit of a selectively permeable membrane (SPM).

There're SPMs with gas separation layer made of silica organic materials with high ratio of water vapours diffusion rate to methane diffusion rate and low ratio of butane, hydrogen sulphide, merkaptans, helium rate to methane diffusion rate. These membranes are efficient only for drying of hydrocarbon mixtures.

Composite membranes to be used for simultaneous treatment of a raw material (HPGM) from water vapours, acid gases and heavy hydrocarbons have selective layers made of block copolymers, consisting of elastic and rigid blocks, for example, membranes made of polyoxyethylene copolymers with polyamide PEG (PEBAX®), polyester and polymide (Polyactive®) etc. With the certain ratios of elastic and rigid membrane block the above mentioned polymers have high selectivity values with preservation of high enough specific permeability. For example, membranes with the selectivity values α (H₂O)/(CH₄)≧280, α (He)/(CH₄)≧150, α (MS)/(CH₄)≧65 (where MS—merkaptans sum), α (H₂S)/(CH₄)≧40, α (C₆H₁₄)/(CH₄)≧25 possess specific permeability of methane at a temperature of 25.0° C.−P/1(CH₄)≧30 l/m ²h atm. Herewith the selectivity values of this membrane on all components are higher than the corresponding values of selectivity of the best silica organic membranes. For example, membrane selectivity values (specific permeabilities ratio) made of polydimethyle siloxane (Lestosil), compose α (H₂O)/(CH₄)≦25, α (He)/(CH4)≦2, α (H₂S)/(CH₄)≦8.

Selective properties of the SPM have decisive significance in the processes of the membrane gas separation. This can be illustrated by the results of numerical modeling of the hydrogen sulphide recovery process from multi-component hydrocarbon mixture represented at FIG. 1, from which it leads that at actual pressure differences at the SPM the product yield (purified gas mixture with the required specifications) per hydrogen sulphide (7 mg/m³ per OST 51.40-93) primarily depends on the selectivity values α (H₂S)/(CH₄), herewith the acceptable yields ≧80% can be achieved only at α (H₂S)/(CH₄)>50. Membranes with such selectivity do not exist at the present time. Therefore it is necessary to find approaches to increase the gas separation efficiency and to improve the gas separation plants characteristics for implementation of the less energy-demanding single-stage membrane separation process. One of these methods is flushing or sweeping of a low-pressure chamber of a membrane gas separating module (MGSM LPC) for decreasing of the partial pressure of the undesired component downstream the selectively permeable membrane.

The method of gas mixtures separation is known from description in the RF Patent for the invention No 2132223, wherein membrane gas separation units (MGSU) with a high-pressure chamber (HPC) and a low-pressure chamber (LPC) are used, separated by the SPM, the raw material (HPGM) goes to the MGSU HPC inlet, and portion of a non-permeate withdrawn from the HPC outlet goes to sweeping of the LPC in the counter-flow direction. The objective of the known technical solution is minimization of the membrane area for single-component purification, i.e. increase of the membrane productivity. However the decrease of the SPM total area proportional to the increase of productivity of the SPM in the plant with certain productivity on the product stripped from one of the components only does not allow to practically obtain the product that would correspond with the requirements on the limiting contents of several non-desired components. Concentrations of non-desired components even though are small, but as a rule differ from each other significantly. If the raw material contains one component in concentration, for example, 0.01 g/m³, and another one in concentration, for example, 0.1 g/m³, then with comparable selectivity of the SPM to both components, the unit with reduced area of the SPM will not be efficient for stripping of the product from the second component, in comparison with the plant without sweeping, wherein the SPM has larger total square area.

As the modeling results provided at FIG. 2 show at the set pressure of the initial gas and set ratio of pressures in the HPC and the LPC of the MGSU b=P(high)/P(low)=20 the sweeping of the LPC with portion of the non-permeate (approximately 15%) increases the product yield (natural gas stripped from hydrogen sulphide) by use of membranes with selectivity of more than 20, herewith at use of membranes with selectivity of less than 20 the yield of the product decreases. The provided results make clear that the LPC sweeping significantly increases the product yield with the required characteristics of hydrogen sulphide. In particular, the product yield increases 80% for actually existing membranes with selectivity α (H₂S/CH₄)≈40. Thus the task of the single-stage purification of hydrocarbon mixture from hydrogen sulphide is solved only by membranes with high selectivity and by sweeping of the LPC.

Relations, given at FIG. 1, are universal and apply to any impurity (water, merkaptans, helium, C₅+ etc.), stripped from the hydrocarbon mixture.

### SUMMARY OF THE INVENTION

The objective of the invention is to obtain methods and plants for purification of the high-pressure gas mixture simultaneously from several components of different chemical origin, even if the quantative contents in the raw material vary significantly and also to increase the efficiency of this purification process.

Terms and expressions used in this text have the following meaning.

A non-permeate denotes non-permeating gas flow stripped from the easily permeating components and enriched with hard permeating components .

A permeate is the gas flow that permeated enriched with easily permeating components.

A membrane gas separation module (MGSM) is a plant for the separation (purification) of the HPGM comprising a high-pressure chamber (HPC) and a low-pressure chamber (LPC) with a selectively permeable membrane (SPM) therebetween.

The term chamber is referred to chambers, sections, channels or any known medium for supply of the gas mixture with high content of easily permeating components at the SPM and collection of the gas mixture permeated through the SPM with decreased content of the easily permeating components. One of the possible particular forms of the MGSM implementation is shown at FIG. 2 and described in the text below.

A membrane gas separation unit (MGSU) is a unit comprising at least one MGSM or at least two MGSMs, inputs and outputs of which are interconnected for the mutual feed or withdrawal of the gas mixtures into/from the MGSU and/or for distribution of the intermediate flows of the gas mixtures between the MGSMs inside the MGSU. HPCs and LPCs of different MGSMs in the MGSU can be connected in parallel, in series, parallel-and-in-series and/or in series-and-parallel based on gas flows.

Head MGSUs in plants comprising several MGSUs refer to the MGSUs at inlet of the HPCs whereof the HPGM is supplied with increased (in relation to flows supplied at inlet of the HPC of other MGSUs) contents of easily permeating components. In other words, if, for example, the plant comprises at least two MGSUs, then the first MGSU in the direction of the purified HPGM flow is the head MGSU.

Tail MGSUs in plants comprising several MGSUs, refer to the MGSU, wherein the HPGM is supplied with decreased contents of the easily permeating components at the HPC inlet (in relation to flows supplied to the HPC inlet of other MGSUs). In other words, if, for example, the plant comprises at least two MGSUs, then the last MGSU downstream the purified HPGM flow is the tail MGSU.

A high-pressure chamber (HPC) is a chamber, section and/or any structurally isolated space dedicated mainly for connecting of HPGM, to the SPM of at least one MGSM.

A low-pressure chamber (LPC) is a chamber, section and/or any structurally isolated space dedicated mainly for collection and takeoff of the gas flow permeated through the SPM of at least one MGSM.

A sweep gas (or sweep gas flow) is referred to portion of the non-permeate collected at the outlet from the HPC of at least one MGSM and/or MGSU, which is used for sweeping of the LPC of at least one MGSM.

A discharge flow (discharge gas or discharge) is referred to gas flow taken from the LPC of at least one MGSM and/or MGSU and that is represented by permeate or mixture of permeate and sweep gas.

A product is referred to gas flow, namely, the non-permeate collected at the outlet from the LPC of at least one MGSM and/or MGSU with the required composition (concerning quality and quantity).

A semi-finished product is referred to the gas flow, namely, the non-permeate collected at the outlet of the HPC of one or several MGSUs and/or MGSMs except the tail ones.

A vacuum compressor (VC) is a unit for decreasing of pressure and supply of the gas mixture from its inlet to its outlet at increased pressure.

A high-pressure gas mixture (HPGM) refers to the gas mixture supplied at the HPC inlet of the MGSM or the MGSU for further treatment from the easily permeating components.

A selectively permeable membrane (SPM) is a layer of material providing different rates of permeability of different components of the gas mixture of different chemical origin.

Other terms and expressions have meanings as regular for the context and the given technical field.

Technical result comprises the possibility of the simultaneous raw material (HPGM) purification from one or several easily permeating components(s) (in particular, helium, hydrogen sulphide, merkaptans, carbon dioxide, water and/or heavy hydrocarbons), increase of the purification efficiency (i.e. ratio between the total area of the SPM in the plant, the productivity of said membrane and the specific energy consumption of the gas separation process); and providing of the possibility of using (treating or preparing) raw material with a higher content of the easily permeating components.

The above-mentioned technical result is achieved by implementation of the plant operation type for purification of the high-pressure gas mixture (HPGM) from the easily permeating components , comprising membrane gas separating units (MGSUs) with a high-pressure chamber (HPC), with a low-pressure chamber (LPC) and a selectively permeable membrane (SPM) therebetween, wherein the LPC of at least one of the MGSUs is swept with a purified gas mixture (semi-finished product or product), wherein the pressure difference between the aforementioned chambers of this MGSU, and ,likewise, the flow rate of the purified gas mixture used for sweeping, are maintained so that the amount of each easily permeating component in the product does not exceed the desired values.

Taking the above into account it is clear that the increase of efficiency of purification of the high-pressure gas mixtures is restrained by the limiting selectivity of existing SPMs. Besides, sweeping of the LPC allows to increase product yield only at values of selectivity of the SPM above the certain limit for all components. Herewith high product yield is achievable due to non-linear dependency of the SPM selectivity and any of the components from the operating pressure difference between high- and low-pressure chambers, only due to the selection of the certain pressure difference between the LPC and the HPC and certain ratio of the sweep gas and the permeate flow purified simultaneously from several components of the gas mixture, without increase of the stages number and use of additional active equipment. Also, in some cases, for increase of the gas separation efficiency it may be useful to provide high absolute pressure values in chambers (for example, for increasing difference in the concentration of the permeating components in the gas mixtures at different sides of SPM) together with provision of the certain pressure difference in between the chambers.

The gas separation is accomplished so that the value of the ratio of specific permeabilities of the SPM (amount of matter or volume of the gas permeated a unit of area of the SPM at a unit of time and at a unit of pressure, mole/m² sec Pa or m³/m² sec Pa) for each easily permeating component to the specific permeability of SPM in relation to all hard permeating components and/or to main hard permeating component exceeded the ratio of pressures in the high-pressure and the low-pressure chambers of the MGSU.

High-pressure chambers of several membrane gas separating units of the plant can be connected between each other differently, in particular, in series.

The HPC of at least one additional MGSU may be connected in parallel to the HPC of at least one of the MGSUs or at least one membrane gas separating unit (MGSU) comprises at least two membrane gas separating modules (MGSM), each of them in its turn comprises a high-pressure chamber (HPC), a low-pressure chamber (LPC) and a SPM therebetween herewith inlets and outlets of the LPC and the HPC of said MGSU or inlets and outlets of said MGSMs are interconnected in parallel.

The gas mixture (discharge flow) from the LPC outlet of at least one of MGSU can be supplied to the HPC inlet of another MGSU by sweeping with semi-finished product of the LPC of both MGSUs.

For provision of optimum pressure, gas mixtures supplied to the HPC inlet of at least the first of the head MGSU can be preliminarily compressed.

In one of the particular implementation forms the gas mixture supplied to the HPC inlet can be pre-cooled for example for removal of the excessive heat from the gas compression or for water vapours or hydrocarbons condensation.

The gas mixtures supplied to the HPC inlet can be preliminarily separated and filtrated for example for condensed moisture and/or mechanical contamination removal.

The gas mixtures supplied to the HPC inlet can be preliminarily heated for example after pre-cooling and before supply of the gas mixture to the high-pressure chamber of the MGSU. It is preferable when the gas mixture is heated to temperature at which the maximum efficiency of the applied SPM is achieved.

The gas mixtures supplied to the HPC inlet, may be preliminarily compressed and/or preliminarily compressed, and then cooled and/or preliminarily compressed, then cooled, then separated, and then filtrated and/or preliminarily compressed, then cooled after that separated then filtrated and then heated.

The pressure decrease below the atmosphere pressure can be provided in the LPC of at least the first of the head MGSU.

It is preferable when said pressure decrease below the atmosphere pressure is obtained in the LPC of the head MGSU.

Sweeping can be arranged in particular in such a way so that the purified gas mixture from the HPC outlet of at least one of MGSU is used for sweeping of the LPC of at least one of the preceding MGSU i.e. product or semi-finished product from the HPC outlet of at least one of the MGSU can be used for sweeping of the LPC of at least one or more preceding MGSUs. It can be beneficial for example for decrease of non-production hydraulic losses at the non-permeate throttling from the HPC to the adjoining LPC for the non-permeate pressure relief (sweeping flow) as the non-permeate (sweeping flow) pressure in the tail stages (if the non-permeate is not compressed in between MGSUs) is usually closer to pressure that is necessary to be provided in the LPC than the non-permeate pressure from the head MGSU due to the natural hydraulic losses in the MGSM. Besides it allows to increase the motion force of the separation process in the head MGSUs as in this case the LPC will be swept with more purified non-permeate than the non-permeate from the head MGSUs HPCs.

Herewith it is preferable when the purified gas mixture from the HPC outlet of at least one MGSU is used for sweeping of the LPC of at least the first of the head MGSUs.

The pressure of the gas mixture used for the LPC sweeping as a rule is decreased beforehand. The pressure decrease may not be needed if portion of the non-permeate with low pressure at the outlet from the HPC of the MGSU of the tail stages is used as sweep gas.

The gas mixtures from the outlet of the LPC of at least one MGSU can be directed to the HPC inlet of at least one of the preceding MGSU for the further re-processing thus recycling is provided and emissions are reduced.

It is preferable when the gas mixtures from the LPC outlet of at least one MGSU are directed to the HPC inlet of at least the first of the head MGSU.

The pressure of the purified gas mixture before sweeping of the LPC can be decreased by different means, for example, by a throttling unit, a porous body or an orifice.

If the SPM productivity is influenced not only by the pressure difference between the HPC and the LPC of the MGSU but also by absolute pressure values in the MGSU chambers (gas compression increases components concentration and diffusion rate through the SPM), in this case increase of pressure in the HPC in order to prevent the SPM damage may be compensated by adequate pressure increase in the LPC so that it provides not only high pressure difference between chambers (not exceeding strength limit of the SPM) but also high components concentration in the HPGM.

The purified gas mixture (sweep gas) can be used for sweeping by a compressor or a vacuum compressor.

If the MGSU productivity is increased by increase of absolute pressure values not only in the HPC but also in the LPC (at maintaining pressure difference not exceeding the strength limit of the SPM), then sweeping of the LPC with the non-permeate from tail MGSUs by a compressor or a vacuum compressor (if it is needed for increase of the non-permeate pressure from the tail MGSU till the required value) may provide for the additional improvement of the gas separation efficiency.

Pressure decrease below the atmosphere pressure in the LPC may be obtained by a vacuum compressor.

Selectively permeable membranes used in the above described method may be accomplished as semi-permeable hollow fibers or flat membranes installed at a frame or spiral-wound membranes. Hollow fiber membranes are preferable.

The discharge flow can be handled differently. The gas mixture from the LPC outlet (discharge flow) of at least one MGSU can be used for power supply (if the latter contains sufficient amount of flammable hydrocarbons) and/or can be compressed and directed to utilization and/or to storage and/or downhole injected (for example, for increase of productivity) and/or can be re-processed.

The purified gas mixture from the HPC of at least one MGSU is directed to the consumer. The non-permeate from the outlet of the tail MGSU (with contents of all components not higher than the specified values) or the non-permeate of intermediate MGSUs or their mixture can be used as product depending on the objective.

It is preferable when the purified gas mixture is directed to the consumer from the HPC of at least one of the tail MGSUs, preferable from the HPC of the tail MGSU.

In order to increase the raw material processing rate, condensate from separation can be stabilized by dividing into the stabilized gas, hydrocarbon condensate and water.

Stabilized gas can be used at the HPC inlet of at least the first of the head MGSUs preferably at the HPC inlet of the first MGSU.

The flows from stabilization can be handled differently. It is preferable that the discharge gas generated during stabilization is directed to utilization, stable hydrocarbon condensate is directed to re-processing or downhole injected and water condensate is downhole injected for maintaining of formation pressure or is directed to utilization.

The above-described method can be implemented with a plant comprising two MGSUs wherein the HPGM is fed to the HPC of the first MGSU, the gas mixture from the HPC of the first MGSU is fed to the HPC of the second MGSU, the gas mixture from the LPC outlet of the second MGSU is fed to the HPC inlet of the first MGSU, the LPC of the first and the second MGSU is continuously swept with the gas mixture of the HPC of the first and second MGSU correspondingly, the pressure in the LPC of the first and second MGSU is decreased by a vacuum-compressor.

Alternatively for implementation of the above described method, the LPC of the first MGSU is swept with the gas mixture from the HPC outlet of the first MGSU and/or from the HPC outlet of the further MGSUs and/or pressure in the LPC of the first MGSU is decreased herewith the gas mixture from its outlet (the LPC of the first MGSU) is directed to the HPC inlet of the second MGSU and/or the HPC inlet of further MGSUs.

The above-described method can also be implemented with a plant comprising two MGSUs wherein the HPGM is supplied to the HPC inlet of the first MGSU, the gas mixture from the HPC outlet of the second MGSU is continuously used for sweeping of the LPC of the first and/or second MGSU and/or the pressure in the LPCs is decreased.

The above-described method can be implemented with a plant comprising two MGSUs wherein the HPGM is supplied to the HPC of the first MGSU, the gas mixture from the outlet of HPC of the first MGSU is continuously used for sweeping of the LPC of the first MGSU and the other portion of the gas mixture is supplied to the HPC inlet of the second MGSU herewith the pressure is decreased in the LPC outlet of the second MGSU and the gas mixture from the LPC outlet of the second MGSU is directed to the HPC inlet of the first MGSU.

It is preferable when the flow rate of the purified gas mixture that is used for sweeping of said LPC (flow rate of the sweep gas flow) and/or pressure in the LPC is set so that to provide the compliance of the product with the requirements on contents of each of easily permeating components within implementation of the above-described method.

It is more preferable when said pressure is set so that to provide the desired degree of purification for each easily permeating component.

It is even more preferable when the flow rate of the purified gas mixture directed to sweeping (flow rate of the sweep gas flow) is selected so that the product yield with contents of each easily permeating component not increasing the desired values shall be increased by at least the flow rate value of the purified gas mixture dedicated to sweeping.

The above mentioned technical result is also achieved in the process of functioning of a plant for the purification of the high-pressure gas mixture (HPGM) from easily permeating components, comprising membrane gas separating units (MGSUs) with a high-pressure chamber (HPC), a low-pressure chamber (LPC) and a selectively permeable membrane (SPM) therebetween that is equipped with means of the pressure regulation in the HPC and the LPC, with envisaged possibility to maintain this pressure difference of at least in one of said MGSUs, and means for sweeping of the LPC with the purified gas mixture (semi-finished product or product), herewith said means are designed so that to provide the pressure difference between the HPC and the LPC and flow rate of the purified gas mixture that is used for the LPC sweeping so that the amount of each of the indicated easily permeating components in the product does not exceed the desired values.

In the preferable implementation form the LPC of at least one MGSU is equipped with the means of pressure decrease.

In one of the particular forms the LPC of at least one MGSU is equipped with methods of pressure decrease and the sweeping with the purified gas mixture is envisaged as a possibility.

In another particular form of the HPCs implementation the MGSUs are connected between each other in series, herewith the LPC of at least one of tail MGSUs is connected with the HPC inlet of at least one of the head MGSUs for return of the discharge flow to the process head. It is preferable when the LPC of tail MGSUs are connected with the HPC of the head MGSU.

In another particular form of implementation the HPC inlet of at least one of MGSUs is connected with the LPC outlet of at least another MGSU via a compressor, a refrigerator, a separator and a filter. This allows to return the discharge flow to the gas separation process after its preliminary purification from easily condensed components.

In the particular form of implementation inlets and outlets of the HPC of at least two MGSUs can be connected between each other in parallel for example for increase of efficiency of the gas separation stage.

In the preferable form of the implementation a refrigerator, a separator and a filter are installed at the HPC inlet of the first of MGSUs. This allows to preliminarily purify the high-pressure gas mixture from easily condensing components.

In more preferable form of implementation said separator is equipped with a condensate stabilization unit with outlets for stabilized gas, for discharge gas, for water condensate and for stabilized hydrocarbon condensate.

In even more preferable form of implementation the outlet of said stabilization unit for stabilizing gas is connected with the HPC inlet of the first MGSU for return of the stabilized gas to the gas separation process head.

The above-mentioned technical result is also achieved in the process of application of the above-mentioned method for simultaneous stripping of the high-pressure natural and associated gas of at least two easily permeating components.

It is preferable when the natural gas is stripped from components selected from a group that includes: water vapour, carbon dioxide, carbon monoxide, hydrogen sulphide, merkaptans and helium.

The above-mentioned technical result is also achieved in the process of application of the above mentioned method for helium recovery from the high-pressure natural gas.

The principles of the method implementation are visually explained at the example of particular and concrete options described below.

### BRIEF DESCRIPTION OF THE DRAWINGS

FIG. 1 shows a schedule that illustrates dependency of the gas mixture yield purified till the required contents of easily permeating components and the SPM selectivity.

FIG. 2 shows a schematic drawing of the MGSM (replaceable cartridge) wherein the sweeping of the inside fiber area is provided by portion of the non-permeate.

FIG. 3 shows a scheme of a plant with connection of MGSUs in series wherein semi-finished product from the first stage of MGSU is directed to the inlet of the second stage MGSU etc.

FIG. 4 shows a scheme of a two-stage plant with a compressor at the inlet to the MGSU HPC of the first stage wherein the recycling is provided (return to the gas separation process head) of the discharge flow from the MGSU LPC of the second stage.

FIG. 5 shows a scheme of a single-stage plant for high-pressure gas mixture purification wherein the sweeping and vacuuming of the membrane gas separation unit LPC is provided.

FIG. 6 shows a scheme of the single-stage plant for high-pressure natural gas purification from helium wherein the sweeping and vacuuming of the membrane gas separating unit LPC is provided.

FIG. 7 shows a scheme of a two-stage plant for purification of the high-pressure gas mixture with connection of both stages of MGSUs in series between each other.

FIG. 8 shows a two-stage scheme for the high-pressure gas mixture purification till parameters of its flow rate with connection of both stages MGSUs between each other in series.

FIG. 9 shows a two-stage plant scheme for the high-pressure gas mixture purification with connection of stages between each other in series wherein each stage comprises separate membrane gas separating units connected between each other in parallel.

FIG. 10 shows a two-stage plant for high-pressure natural or associated petroleum gas wherein the discharge flow from the first stage is purified at the second stage.

FIG. 11 shows a two-stage plant scheme for drying of high-pressure natural or associated petroleum gas wherein the discharge flow of the first stage is purified at the second stage.

FIG. 12 shows the two-stage plant scheme for drying of high-pressure natural or associated petroleum gas wherein the discharge flow from the first stage is purified at the second stage.

### DETAILED DESCRIPTION OF THE PREFERRED EMBODIMENTS

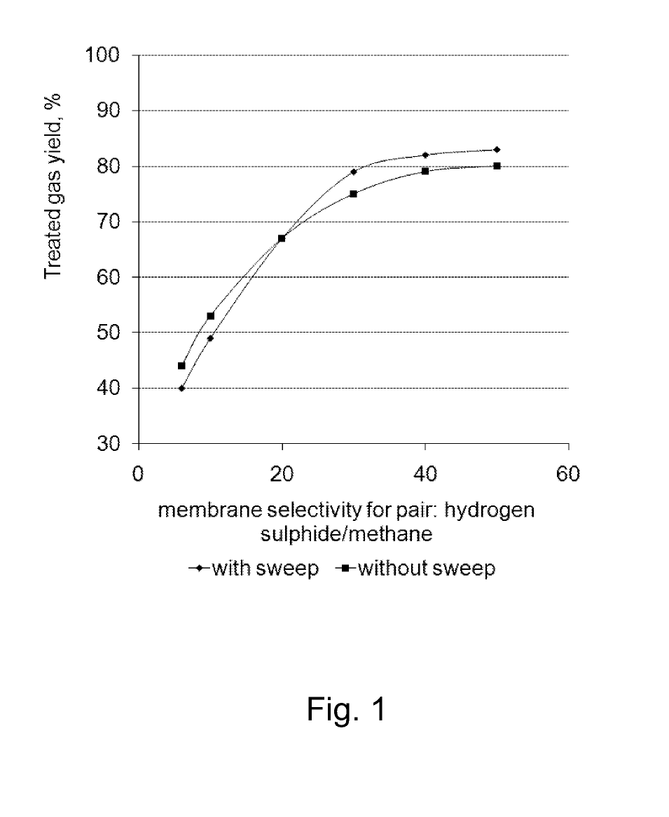

Taking into account the dependency of the SPM selectivity on pressure difference the yield of the product with required contents of water vapours, merkaptans, hydrogen sulphide and hexane is increased due to sweeping of the LPC with the non-permeate only at such pressure difference that provides a selectivity of no lower than the set value (no lower than 20 for hydrogen sulphide as shown at FIG. 1). Herewith the ratio of the sweep gas flow to the permeate flow is chosen based on the required rating of the most hard-to-remove component. In this case the contents of the other components will correspond with the specified standards.

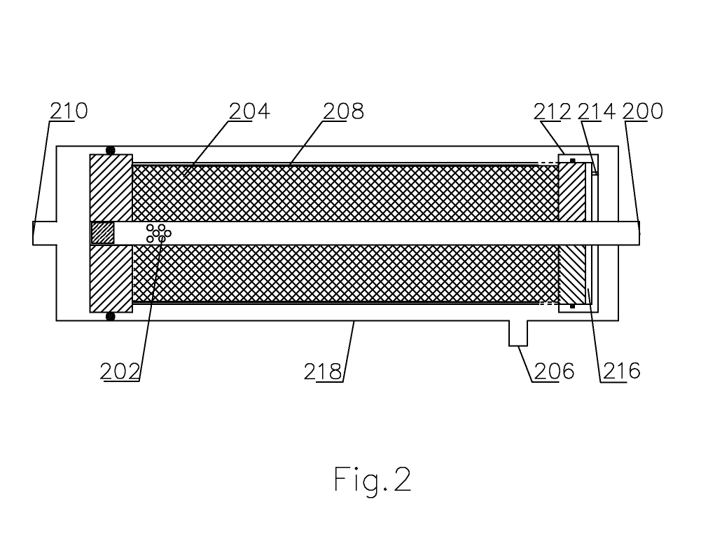

Membrane gas separating units may be constructed by combining membrane gas-separating modules (MGSM), shown at FIG. 2. The raw material is fed under pressure to the MGSM axial manifold 200 and by ports at the manifold end 202 is introduced into the module inter-fiber space 204 (MGSM HPC). The gas flows along the SPM to the outlet 206. Most part of the SPM is coated with coating non-permeable for gases 208. Easily permeating components from the HPC through the SPM permeate to the LPC and migrate to the outlet from the LPC (permeate outlet) 210. It is preferable when flows of the HPC and the LPC are transported along the SPM by counter-flow. A cap 212, hermetically fastened at a housing 218 is located at the end of the MGSM opposite the permeate outlet. The cap has an opening 214 for installation of replaceable orifices. The purified gas is supplied inside the fibers (MGSM LPC) through the orifice and is used for sweeping of the MGSM LPC 216.

Sweeping leads to decrease of concentration of easily permeating components in LPC, thus increasing the gases partial pressure differences between the HPC and the LPC. The purification process of the HPGM from the easily permeating components is improved because the driving force of the separation process is the gases partial pressure differences at the SPM. At the same time the concentration of hard permeating components along the SPM is changed insignificantly, and the partial pressure difference also decreases insignificantly. Decrease of the partial pressure difference deteriorates the purification process of the HPGM from the hard permeating components.

The value of the permeate flow for every single fiber at the set pressure difference on it depends only on the temperature of the permeating gas mixture and composition of the permeating gas. The value of the sweep gas flow in the first turn depends on the orifice dimensions (orifice diameter and length), pressure drop on it and hardly depends on the temperature and viscosity of the gas flowing through an orifice. Thus the easiest way to change the ratio of the permeate and the sweep gas flow is by changing the dimensions of the orifice.

The gas mixture at the outlet from the LPC is the discharge flow. The ratio of this flow to the flow of HPGM (at identical product parameters) determines the efficiency of the purification process. The lower the ratio is the more efficient is the operation of the MGSM. From the above-said it follows that it is necessary to optimize the ratio of the permeate and the sweeping flows for provision of the necessary gas purification from easily permeating components. The ratio between the permeate flow and the sweep gas flow is set at the stage of manufacturing of the MGSMs on the basis of results of the purification process numerical modeling and preliminary testing of the MGSM.

If product with set contents of all easily permeating components can not be obtained in a single-stage process then more complicated purification schemes are used, in particular schemes with connection of MGSUs in series when the semi-finished product of the first stage is directed to the MGSU inlet of the second stage etc.

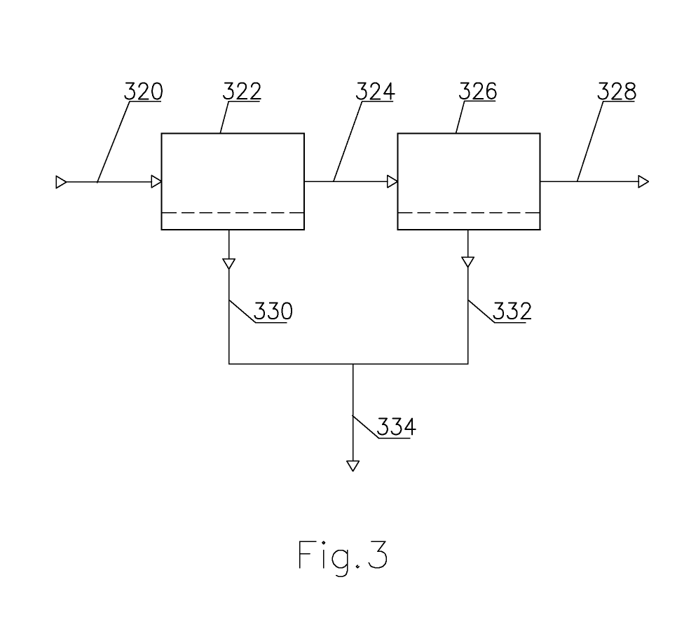

The principal scheme of such MGSU connection is shown at FIG. 3.

As shown at FIG. 3 the raw material (HPGM) by a pipeline 320 is supplied to the MGSU inlet of the first stage 322, a semi-finished product from the first stage by a pipeline 324 is supplied to the second stage 326 MGSU inlet, whereof a product 328 with set concentrations of components is directed to the consumer. A permeate 334 from the first 330 and from the second stage 332 is the discharge flow. The number of stages may be more than two. These schemes are often applied if the raw material is under pressure. As matter of actual practice each stage in gas separating units may comprise several connected in parallel MGSMs and/or MGSUs. At set pressure and temperature of the HPGM the number of MGSMs and/or MGSUs in the MGSU of each stage is determined by flow rate of the HPGM and the selection ratio i.e. the ratio of the raw material and product flows.

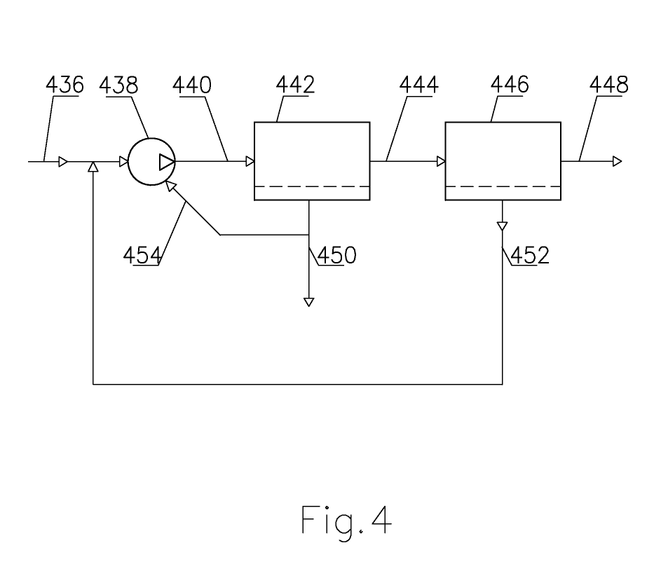

The scheme with recycling can be used for example as shown at FIG. 4 if the raw material is compressed before supply to the MGSU. In line with this scheme the raw material 436 is comingled with the permeate of the second MGSU 452, is compressed by a compressor 438 and the obtained HPGM by a pipeline 440 is supplied to the inlet of the first MGSU 442 whereof the non-permeate by the pipeline 440 is supplied to the inlet of the second MGSU 446. The product from the second MGSU 448 is directed to the consumer. The permeate from the first MGSU 450 is utilized and the permeate from the second MGSU 452 is supplied to the compressor inlet. For membrane gas-separating units with recycling (i.e. with the permeate return to the gas separation process head) only the permeate of the head MGSU(s) is the discharge flow (i.e. the first MGSU or several head MGSUs including the first one).

The discharge flow may be collected for additional treatment at oil petroleum or chemical plants or can be used as auxiliary for example for indoor heating or for heating of intermediate gas flows depending on the discharge flow composition.

In line with the option represented at FIG. 4 the permeate is returned to the process head from the second stage 452. In addition to this permeate of the first stage by a pipeline 454 may be fed to the compressor 438 power supply. In this case the number of MGSUs and/or MGSMs of the first stage and operation conditions are selected in such a way that the permeate flow would correspond with the volume gas flow rate necessary for the compressor supply.

### EXAMPLE 1

### Purification of High-Pressure Associated Gas From the Water Vapours at a Single-Stage Plant

The raw material (the HPGM with a pressure of 60 bar with content of water 0.07% mole, methane 93.6% mole, CO2 2.9 mole, other: hydrocarbons C2-C5) is supplied by the inlet nozzle inside the plant comprising an MGSU with MGSMs connected in parallel on the basis of hollow fibers (structure of MGSM is shown at FIG. 2 and described above). The raw material is supplied to the MGSM HPC (inter-fiber space). Portion of the gas (permeate) from the HPC permeates through walls to the LPC (internal fibers channels) when passing along the fibers. The product obtained at the outlet from the HPC (non-permeate) is divided into two parts. The main portion is deviated by the corresponding nozzle under a pressure of 59 bar. The less portion (sweep gas flow) is supplied to the chamber above the open part of fibers opposite an outlet nozzle through the orifice in the internal cap, whereof it is directed to the internal fiber channels and is commingled with the permeate that permeated the fiber wall after that the obtained mixture of the permeate and the non-permeate is withdrawn from the LPC by the nozzle under a pressure of 2.0 bar.

The pressures ratio in chambers was estimated as P(high)/P(low)=30, the specific permeabilities ratio (selectivity) on water and methane P/1(H₂O)/P/1(CH₄)=280, thus P/1(H₂O)/P/1(CH₄)>P(high)/P(low), the permeate percent in the raw material flow is 4.6%; the percent of product used for sweeping 2.9% from the raw material; contents of water in the residual flow 0.0025% mole, methane 94.6% mole, CO₂ 2.4% mole. The contents of water in residual flow without sweeping is 0.03% mole, methane 94.6% mole, CO₂ 2.4% mole.

### EXAMPLE 2

### High-Pressure Associated Gas Purification From Hydrogen Sulphide at a Single-Stage Plant

The raw material (HPGM with a pressure of 20 bar and hydrogen sulphide contents of 0.02% mole, methane 88.9% mole, CO₂ 3.3% mole, nitrogen 0.2% mole, other: hydrocarbons C₂-C₅) was supplied by an inlet nozzle inside the plant comprising MGSU with MGSMs connected in parallel on the basis of hollow fibers (MGSM structure is shown at FIG. 2 and described above). Passing along fibers, the high-pressure gas mixture components from a HPC (inter-fiber space) permeate through fiber walls to a LPC (internal fibers channels), herewith the mixture is stripped from easily permeating components, and the product obtained in the result (non-permeate) is divided into two parts. The main portion of the non-permeate is withdrawn by a corresponding nozzle under a pressure of 19 bar. Less portion of the non-permeate (sweep gas flow) through an orifice in the internal cap is supplied to the chamber above the open part of the fibers opposite the outlet nozzle whereof the non-permeate is supplied to the channels inside the fibers and is commingled with the permeate permeated through the fiber wall, thereafter the obtained mixture is deviated by a nozzle under a pressure of 1.2 bar.

The ratio of pressures in chambers was estimated as P(high)/P(low)=16, the specific permeability ratio (selectivity) per hydrogen sulphide and per methane P/1(H₂8)/P/1(CH₄)=40, herewith P/1(H₂S)/P/1(CH₄)>P(high)/P(low); percent of the permeate in the raw material flow is 8.4%, percent of product used for sweeping is 4.5% of the raw material flow, hydrogen sulphide content in product is 0.003% mole, methane—91.1% mole, CO₂—2.2% mole. Percent of hydrogen sulphide in product without sweeping (MGSMs with blind orifices were used) was estimated as 0.008% mole, methane —1.1% mole, CO₂—2.2%

### EXAMPLE 3

### Purification Of High-Pressure Associated Gas From Hexane at a Single-Stage Plant

The raw material (HPGM under a pressure of 14 bar with contents of hexane 0.95% mole, methane 70.5% mole, water 0.55% mole) by an inlet nozzle is supplied into the plant comprising an MGSU with MGSMs connected in parallel on the basis of hollow fibers (MGSM structure is shown at FIG. 2 and described above). The raw material is introduced into a MGSU HPC (inter-fiber space). When passing along fibers the components of the gas mixture from the HPC permeate the fibers wall in a LPC (internal channels of fibers). The product (non-permeate) is divided into two parts. The main portion is withdrawn by a corresponding nozzle under a pressure of 14 bar. The less portion is supplied to the chamber above the open part of fibers through an orifice in the internal cap, opposite the outlet nozzle whereof it is directed to sweeping of the internal fibers channels where it is commingled with the permeate that permeated through the fiber wall. The obtained gas mixture is deviated by a nozzle under a pressure of 1.2 bar.

The ratio of pressures in chambers of the MGSM was P(high)/P(low)=12.5, the specific permeabilities ratio (selectivity) for hexane and methane P/1 (C₆H₁₄)/P/1 (CH₄)=25, thus P/1(C₆H₁₄)/P/1(CH₄)>P(high)/P(low); portion of the permeate is estimated as 11.5% of the raw material flow, the percent of gas passing through an orifice is 4.5% of the raw material flow; hexane content in product is estimated as 0.15% mole, methane 75.5% mole, water 0.08% mole. Without sweeping (MGSM with blind orifices was used) the hexane content in product is estimated as 0.27% mole, methane 75.5% mole, water 0.24% mole.

### EXAMPLE 4

### Single-Stage Plant With Sweeping and Vacuuming of the Low-Pressure Chamber of the Membrane Gas Separating Unit for the High-Pressure Gas Mixture Purification

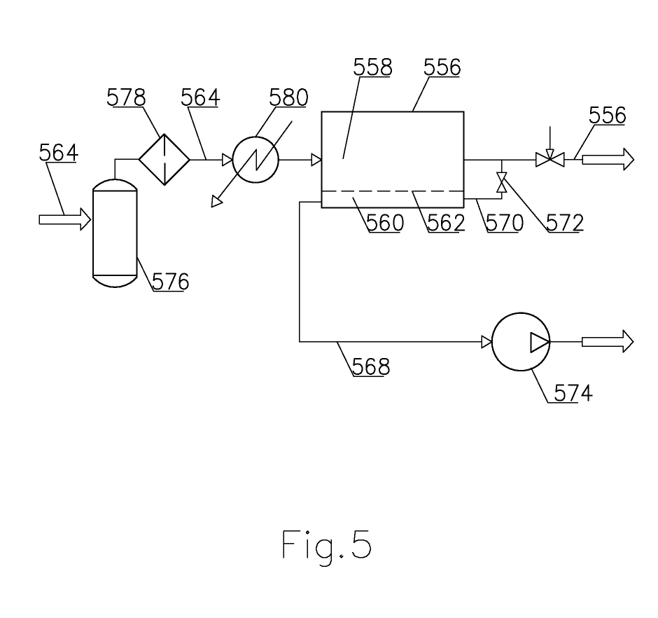

As shown at FIG. 5 the plant comprises an MGSU 556 with a HPC 558 and a LPC 560, with a SPM 562 therebetween. The raw material (HPGM) 564 is supplied to the HPC 558 of the MGSU 556, the product (non-permeate) 566 is obtained from the HPC outlet, and the discharge flow 568 is taken away from the LPC outlet (mixture of the permeate and the sweep gas), portion of product 570 (sweep gas) is used for sweeping of the LPC 560 after throttling in an orifice 572, and pressure in the LPC 560 is decreased by a vacuum-compressor 574, thus providing a possibility to change the pressure ratio of gas flows in the HPC 558 and the LPC 560.

If necessary the raw material is separated in a separator 576 and/or filtrated at a filter 578 for condensate and mechanical mixtures removal and also heated in a heat-exchanger 580 before the raw material is supplied to the MGSU 556.

The flow rate of sweep gas 570 and pressure difference between the HPC 558 and the LPC 560 are selected from the conditions of maximum product yield and minimum specific energy consumption for the purification process. Thus the increase of the separation efficiency of the LPC with the minimum energy consumption is provided due to sweeping.

The contents of the non-desired impurities in product may be decreased in two or more times.

### EXAMPLE 5

### Purification Of Natural Gas From Helium at Plant Per Example 4

The raw material namely crude natural gas under a pressure till 10 MPa, containing 0.6% mole helium, is supplied to the MGSU. Before supply of the raw material to the MGSU the raw material is separated and filtrated for removal of condensate and mechanical impurities and then is heated till a temperature of 50° C. The product with contents of helium of 0.1% mole from the MGSU under a pressure of 9.8 MPa is directed to the consumer. Approximately 5% of product (the non-permeate), is directed to the MGSU for sweeping of the LPC. The gas mixture at the outlet of the LPC (discharge flow) with contents of helium 4.5÷5% mole has a pressure of 0.05 MPa, provided by the vacuum compressor that then compresses the gas mixture up to a pressure of 15 MPa. The discharge flow is directed either to utilization to storage, or is downhole injected, or is re-processed. The capacity of vacuum compressor and throttling parameters of the sweep gas are chosen on condition of maintaining of optimum pressure difference in the MGSU chambers.

### EXAMPLE 6

### Purification of Natural Gas From Hydrogen Sulphide at the Plant Per Example 4

The raw material namely natural gas with a pressure of 2.5 MPa and a temperature of 25÷30° C., with 150 mg/m³ of hydrogen sulphide, is supplied to the MGSU. Preliminarily the raw material is purified from condensate and mechanical impurities. A coalescing-type filter is to be used. The product with the content of hydrogen sulphide no more than 20 mg/m³ under a pressure of 2.2 MPa is directed to the consumer. The portion of product, approximately 5%, is directed to the MGSU for sweeping of the LPC. The discharge flow collected from the LPC outlet, contains hydrogen sulphide up to 1500 mg/m3 and has a pressure of 0.1 MPa, provided by the vacuum compressor and then the gas mixture flow is compressed till a pressure of 0.2 MPa.

The capacity of the vacuum compressor and sweep gas throttling parameters are chosen on the basis of maintaining the optimum pressure difference in the MGSU chambers.

### EXAMPLE 7

### Purification of Natural Gas From the Water Vapours at the Plant Per Example 4

The raw material namely natural gas under a pressure of 2.8 MPa and a temperature of 45° C. with 100% relative humidity (per water) is supplied to the MGSU. The raw material is separated and filtrated for removal of condensate and mechanical impurities before supply of the raw material to the MGSU. The product is supplied to the consumer with contents of water no higher than 0.012% mole (that corresponds with the water dew point temperature of minus 10° C. at the above-indicated pressure). The portion of product (sweep gas) approximately 6% is directed to the MGSU for sweeping of the LPC. The discharge flow contains up to 3.0% mole of water.

The vacuum compressor provides for pressure decrease in the LPC till 0.05 MPa and supply of the discharge flow for the further reprocessing under a pressure of 0.15 MPa. The efficiency of the vacuum-compressor and throttling parameters of the sweep gas are selected on condition of maintaining of the optimum pressure difference in the MGSU chambers.

### EXAMPLE 8

### Purification of Natural Gas From Hydrocarbons Containing 4 and More Carbon Atoms at the Plant Per Example 4

The raw material namely associated petroleum gas under a pressure of 1.6 MPa with contents of hydrocarbons C₄₊8.0% mole is cooled till temperature of 20° C. in the refrigerator. Then before supply to the MGSU the associated gas is consequently purified from condensate and mechanical impurities in the separator and the coalescing filter. The purified gas is supplied to the inlet of the HPC of the MGSU, and product with contents of hydrocarbons C₄₊ with no more than 2.0% mole is directed to the consumer. Portion of product (sweep gas) is directed to the MGSU for sweeping of the LPC. The discharge flow contains 15% mole of C₄₊ hydrocarbons.

The vacuum compressor maintains pressure in the LPC up to 0.04 MPa and supplies the discharge flow for the further re-processing under a pressure of 0.12 MPa. The capacity of the vacuum compressor and natural gas throttling parameters are chosen on condition of maintaining optimum pressure difference in the MGSU chambers.

### EXAMPLE 9

### Purification of the High-Pressure Natural Gas From Helium at the Single-Stage Plant With Sweeping and Vacuuming of Low-Pressure Chamber of the Gas Separating Unit

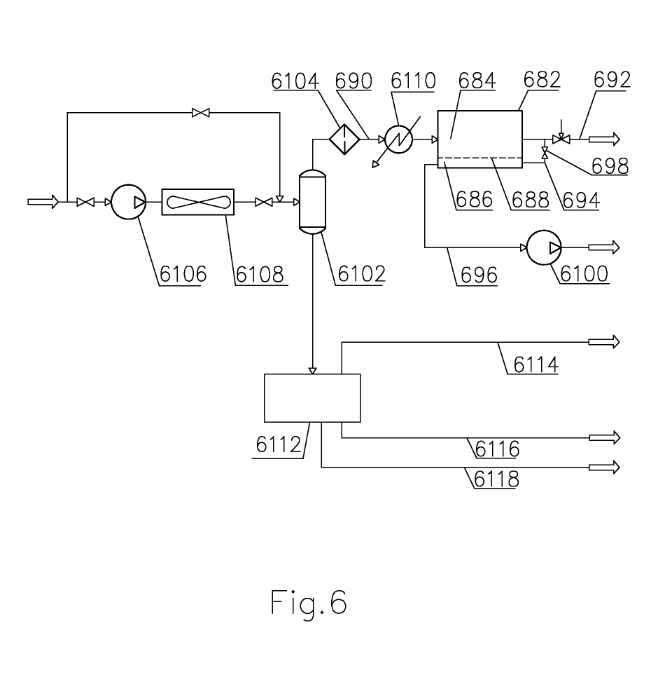

As shown at FIG. 6 the plant for purification of natural gas from helium comprises a MGSU 682 with a HPC 684 and a LPC 686, separated by a SPM 688. The HPC 684 from one side is connected with a pipeline 690 and with a pipeline 692 from the opposite side. The LPC 686 is connected with a sweeping channel 694, interconnected with the pipeline 692 and a pipeline 696, herewith a throttling element 698 is installed in the sweeping channel 694. A vacuum-compressor 6100 is installed at the pipeline 696 and provides for the possibility of pressure decrease in the LPC 686 and supply of the gas mixture from the LPC 686 to utilization in the storage area or either for downhole injection or for re-processing. The plant can be equipped with a separator 6102 and a filter 6104 installed in series at the supply pipeline 690 for purification of natural gas from condensate and mechanical impurities. A compressor 6106 and a refrigerator 6108 can be installed in series upstream the separator 6102 at the supply pipeline 690. Besides it may be equipped with a heater 6110, installed at the supply pipeline 690 directly upstream the MGSU 684. The plant may be equipped with a condensate stabilization unit 6112, connected by its inlet with the condensate outlet of the separator 6102 and with three outlets , the first of which is connected to a pipeline 6114 of gas discharge to utilization or flaring, the second one is connected to a pipeline 6116 for the hydrocarbon withdrawal to the further reprocessing or for downhole injection and the third one is directed to a pipeline 6118 for water condensate removal.

The raw material i.e. high-pressure natural gas with helium contents of 0.2÷1.0% mole, is supplied to the HPC 684 of the MGSU 684 by the pipeline 690. Preliminarily the raw material is purified from condensate and mechanical impurities in the separator 6102 and the filter 6104, the latter can be of a coalescing type. The raw material temperature before supply to the MGSU 682 may be increased in the heater 6110. In case of the raw material low-pressure the raw material is preliminarily compressed in the compressor 6106 and then cooled in the refrigerator 6108. Preliminarily purified raw material is supplied to the HPC 684 of the MGSU 682 whereof a product with helium contents of 0.1% mole is directed to the consumer by a pipeline 692. Portion of product (sweep gas) from the pipeline 692 per a channel 694 with a throttling element 698 is directed to the LPC 686. The discharge flow with contents of helium 1.5÷5.0% mole is deviated from the LPC 686 by a pipeline 696 by the vacuum-compressor 6100 ensuring pressure decrease in the LPC 686 and supply of the discharge flow to utilization, to storage, for the downhole injection or for the further reprocessing. The capacity of the vacuum compressor 6100, the throttling element 698 parameters in the channel 694 and the gas mixture pressure in the pipeline 696 are selected on condition of maximum for the applicable MGSU 682 rate of the purified gas recovery, and correspondingly minimum energy consumption of the purification process.

The condensate from the separator 6102 is directed either directly to utilization for example by downhole injection for maintaining of the formation pressure or is supplied to the condensate stabilization unit 6112 if available at the plant. In the latter case three flows derive from the condensate stabilization unit 6112 namely gas is discharged for utilization or flaring by the pipeline 6114, the hydrocarbon condensate is deviated for the further reprocessing or for downhole injection by the pipeline 6116 and the water condensate is deviated by the pipeline 6118.

The vacuum compressor 6100 and the channel 694 with the throttling element 698 provide for the stable and efficient operation of the MGSU 682 that allows to increase the rate of helium recovery and decrease the energy consumption for the purification process. Stable operation of the MGSU 682 is also provided by means for the preliminary purification of the natural gas, i.e. the separator 6102, the filter 6104 and the heater 61 10. Besides the plant design provides for the natural gas purification wastes utilization.

### EXAMPLE 10

### The High-Pressure Gas Mixture Purification at a Two-Stage Plant With Stages Connected in Series

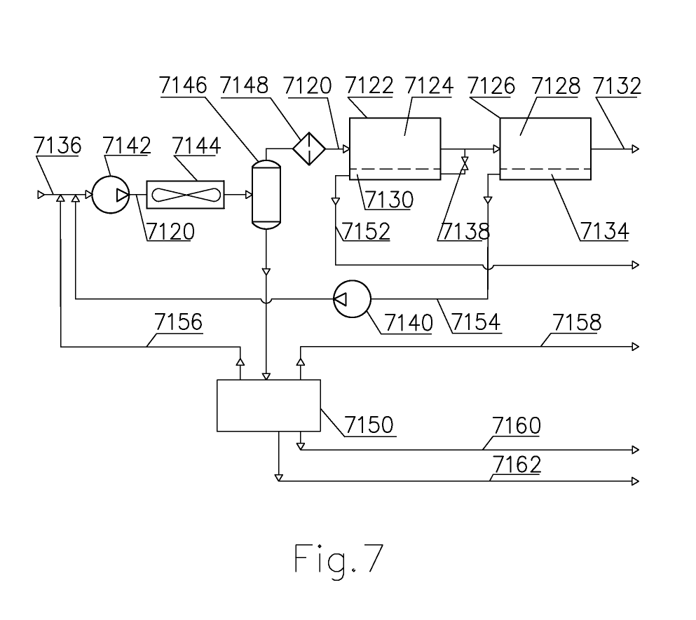

HPGM by a pipeline 7120 is supplied to a HPC 7124 of the first MGSU 7122; the semi-finished product (non-permeate) from the HPC 7124 of the first MGSU 7122 is supplied to a HPC 7128 of the second MGSU 7126 as shown at FIG. 7; the permeate 7152 from a LPC 7130 of the first MGSU 7122 is utilized, product 7132 (non-permeate) is collected at the outlet of the HPC of the second MGSU 7126, the permeate 7154 from a LPC 7134 of the second MGSU 7126 is supplied to a raw material pipeline 7136, the portion of the semi-finished product is deviated (sweep gas) from the outlet of the first MGSU 7122 and through a throttling element 7138 is deviated to sweeping of the LPC 7130 of the first MGSU 7122, herewith the pressure is decreased in the LPC 7134 of the second MGSU 7126 by a vacuum compressor 7140.

The capacity of the vacuum compressor 7140 is selected so that to provide for the maximum pressure difference at a SPM. The amount of the sweep gas is chosen on condition of the maximum gas separation efficiency.

The discharge flow from the LPC 7134 of the second MGSU is sucked and compressed by the vacuum compressor 7140. Then for purification of the HPGM from condensate and mechanical impurities the HPGM is cooled 7144, separated 7146 and is filtrated 7148 before the direct supply of the HPGM to the HPC 7124 of the first MGSU 7122. The condensate flow from a separator 7146 is directed to a condensate stabilization unit 7150 with four outgoing flows the first whereof as the gas flow of stabilization 7156 is supplied to the raw material flow for reprocessing, the second discharge gas flow 7158 is directed for utilization, the third stable hydrocarbon condensate 7160 is directed to the further reprocessing or downhole injected, the fourth water condensate flow 7162 is directed to the downhole injection for maintaining of the formation pressure or is directed to the utilization.

The efficient separation of the gas mixture and increase of the efficiency of the method in the whole is provided by sweeping of the LPC 7130 of the first MGSU 7122 and maintaining of the decreased pressure in the LPC 7134 of the second MGSU 7126.

### EXAMPLE 11

### The High-Pressure Gas Mixture Purification at the Two-Stage Plant With Stages Connected in Series Till Parameters of its Consumption

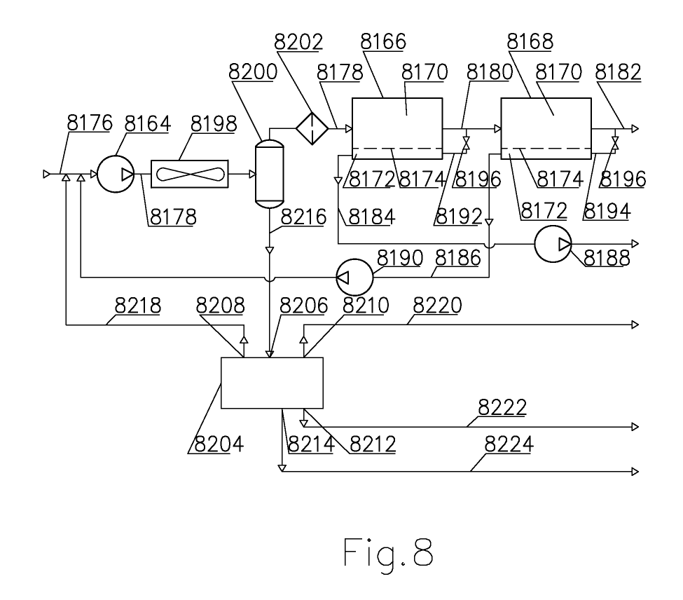

As shown at FIG. 8 the plant of the multi-stage HPGM purification comprises a compressor 8164 and two MGSUs 8166 and 8168 connected in series with high-and low-pressure chambers 8170 and 8172, separated by a SPM 8174. The inlet of the compressor 8164 is connected with a pipeline for the raw material supply 8176, and outlet is connected by a pipeline 8178 of the HPGM supply with the inlet to a HPC MGSU 8166, the MGSU HPC outlet 8166 is connected by a pipeline 8180 with the inlet of a HPC MGSU 8168. The outlet of the HPC of the MGSU 8168 is connected with a pipeline 8182 of the purified gas mixture supply to the consumer. A LPC of the MGSU 8166 is connected with a pipeline 8184, and a LPC of the MGSU 8168 is connected by a pipeline 8186 with the pipeline 8176. The plant is equipped with vacuum compressors 8188 and 8190, herewith the vacuum compressor 8188 is installed at the pipeline 8184, and the vacuum compressor 8190 is installed at the pipeline 8186. The MGSUs 8166 and 8168 are equipped with channels 8192 and 8194 for sweeping of the LPCs 8172. The channels 8192 and 8194 are designed so that to provide a possibility to supply portion of the purified gas mixture from the HPCs 8170 of the MGSUs to the LPCs 8172. The channels 8192 and 8194 are equipped with throttling elements 8196, for example, an orifice for withdrawal portion of the product or semi-finished product from the HPC 8170 of the MGSU.

The channels 8192 and 8194 may be implemented in the structure of the corresponding MGSU itself. The first and second sweeping channels 8192 and 8194 can be arranged by pipelines herewith the pipeline of the first sweeping channel 8192 is connected with the deviating non-permeate flow of the pipeline 8180 from the first MGSU 8166 at one end and to the low-pressure chamber 8172 at another end and pipeline of the second sweeping channel 8194 is connected to the pipeline 8182 of the purified gas mixture supply to the consumer by one end and to the low-pressure chamber 8172 of the second MGSU 8168 by another end.

The plant can be equipped with a refrigerator 8198, a separator 8200 and a filter 8202 installed at a pipeline 8178 in series for purification of natural gas from condensate and mechanical impurities.

In addition, the plant may be equipped with a condensate stabilization unit 8204 with one inlet 8206 and four outlets 8208, 8210, 8212 and 8214. The inlet 8206 of the condensate stabilization unit 8204 is connected with a pipeline 8216 of condensate removal from the separator 8200. The first outlet 8208 of the condensate stabilization unit 8204 is connected by a pipeline 8218 of the gas stabilization flow supply with a pipeline 8176 of the raw material supply for reprocessing. The second outlet 8210 is connected with a pipeline 8220 of the gas mixture flow discharge to utilization. The third outlet 8212 is connected with a pipeline 8222 of the stable hydrocarbon condensate takeoff to further reprocessing or to downhole injection, and the fourth outlet 8214 is connected with a pipeline 8224 of water condensate takeoff for downhole injection in order to maintain formation pressure or to utilization.

By the pipeline 8176 of the raw material supply, for example, feed natural or associated gas, the gas mixture under a pressure, for example, 0.12÷0.15 MPa is supplied to the compressor inlet 8164. The HPGM under a pressure of ,for example, 2.5 MPa from the compressor 8164 outlet is supplied by the pipeline 8178 to the LPC 8170 of the first MGSU 8166. The non-permeate from the HPC of the first MGSU 8166 by the pipeline 8180 is directed to the LPC 8170 of the second MGSU 8168. The non-permeate with reduced impurities contents, for example, heavy hydrocarbons, water and carbon dioxide, from the second MGSU 8168 is directed to the pipeline 8182 for supply to the consumer. From the LPC 8172 of the first MGSU 8166 the permeate under the membrane 8174 with increased contents of impurities, for example, heavy hydrocarbons, water and carbon dioxide, is directed to utilization. From the LPC 8172 of the second MGSU 8168 the permeate is directed by a pipeline 8186 to the pipeline 8176 of the raw material supply. Certain portion of the non-permeate is continuously withdrawn from the high-pressure chambers 8170 to the LPC 8172 of the relevant MGSU for sweeping, herewith the pressure is decreased in the LPC 8172 of each MGSU 8166 and 8168 by the vacuum compressors 8188 and 8190 in each MGSU 8166 and 8168 through the sweeping channels 8192 and 8194 with the throttling elements 8196. The sweeping of chambers 8172 and decrease of pressure therein leads to increase of the gas separation efficiency. The capacity of the vacuum compressors 8088 and 8190 is chosen on condition of provision of the maximum value of pressure ratio at the gas separating membrane 8174 of the membrane modules 8166 and 8168. The amount of gas to sweeping is chosen on condition of provision of the maximum gas separation efficiency in the MGSUs 8166 and 8168. In some cases, a refrigerator 8198, a separator 8200 and a filter 8202 are installed in series upstream the direct supply of the high-pressure gas mixture to the high-pressure chamber 8170 of the first MGSU 8166 at the high-pressure pipeline 8178, that allows to remove condensate and mechanical impurities from the gas mixture. The condensate flow from the separator 8200 by the pipeline 8216 of condensate take-off is directed to the inlet 8216 of the condensate stabilization unit 8204. From the first outlet 8208 of the condensate stabilization unit 8204 at the pipeline 8218 the flow of stabilized gas is fed to the pipeline 8176 of the raw material supply, where the flows are commingled. The gas mixture flow is discharged to utilization by the pipeline 8220 from the second outlet 8210 of the condensate stabilization unit 8204. The stabilized hydrocarbon condensate is deviated for the further reprocessing or for downhole injection from the third outlet 8212 by the pipeline 8222, and the water condensate that may be used for downhole injection to maintain formation pressure or to the utilization is deviated from the fourth outlet 8214 by the pipeline 8224.

Thus the efficient separation of the gas mixture is provided and the efficiency of the plant in general is increased by sweeping of the LPC and maintaining decreased pressure therein.

### EXAMPLE 12

### The High-Pressure Gas Mixture Purification at a Two-Stage Plant With Stages Connected in Series, Each of the Stages Comprising Membrane Gas Separating Units Connected Between Each Other in Parallel

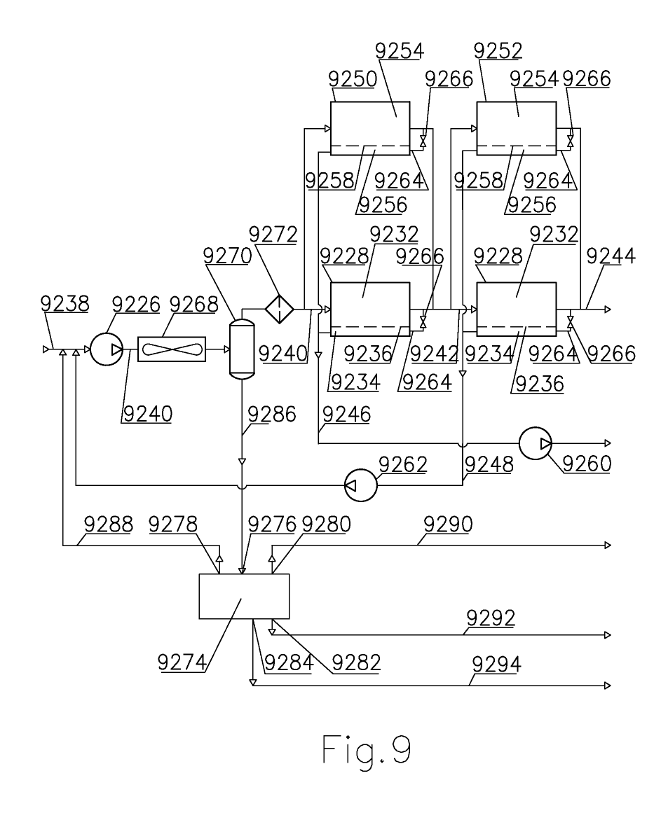

As shown at FIG. 9 a multi-stage gas mixture purification plant comprises a compressor 9226, the first MGSU 9228 and the second MGSU 9230 with HPCs and LPCs 9232 and 9234, separated by SPMs 9236. The compressor 9226 inlet is connected with a pipeline 9238 of raw material supply, and outlet is connected with a pipeline 9240 with a HPC 9232 inlet of the first MGSU 9228, the outlet whereof is connected by a pipeline 9242 with a HPC 9232 inlet of the second MGSU 9230. The outlet of the HPC 9232 of the second MGSU 9230 is connected with a pipeline 9244 for supply of the purified gas mixture to the consumer. The LPC 9234 of the first MGSU 9228 is connected with a pipeline 9246 for the permeate removal for the further reprocessing or utilization, and the LPC 9234 of the second MGSU 9230 is connected by a pipeline 9248 with the raw material supply pipeline 9238. The plant is equipped with additional membrane units 9250 and 9252 with high-and low-pressure chambers 9254 and 9256, separated by a selectively permeable membrane 9258, herewith units 9250 are connected to the first membrane unit 9228 in parallel, and units 9252 are connected to the second membrane unit 9230 in parallel, and to two additional vacuum compressors 9260 and 9262, herewith the first additional vacuum compressor 9260 is installed in the pipeline 9246, the second vacuum compressor 9262 is installed in the pipeline 9248. Each unit 9228, 9230, 9250 and 9252 is equipped with channels 9264 that are provided for a possibility of the continuous supply of the portion of the permeate for sweeping from the HPCs 9232 and 9254 to the LPCs 9232 and 9256 correspondingly.

There can be more additional membrane units 9250 connected to the first MGSU 9228 than additional MGSUs 9252 connected to the second MGSU 9230. The number of MGSUs installed in parallel is selected on condition of provision of the most optimum gas separation process at each stage and most efficient operation of the whole plant in general.

Each channel 9264 for sweeping of LPCs 9234 and 9256 may have a throttling element 9266, for example, an orifice, for provision of collection of the exact certain portion of the non-permeate from the HPCs 9232 and 9254. The channels 9264 for sweeping can be envisaged in the structure itself of the relevant MGSU or by pipelines arrangement.

The plant can be equipped with a refrigerator 9268, a separator 9270 and a filter 9272 in a pipeline 9240 installed in series for purification of natural gas from condensate and mechanical particles.

In addition the plant can be equipped with a condensate stabilization unit 9274, with one inlet 9276 and four outlets 9278, 9280, 9282 and 9284. The inlet 9276 of the condensate stabilization unit 9274 is connected with a pipeline 9286 of the condensate removal from the separator 9270. The first outlet 9278 of the condensate stabilization unit 9274 is connected with a pipeline 9288 of feed gas flow stabilization with the raw material supply pipeline 9238 for return to the purification. The second outlet 9280 is connected with a pipeline 9290 of the gas mixture flow discharge to utilization. The third outlet 9282 is connected with a pipeline 9292 of the stable hydrocarbon condensate removal for the further reprocessing or for downhole injection, and the fourth outlet 9284 is connected with a pipeline 9294 for the water condensate removal for downhole injection to maintain the formation pressure or to utilization.

Raw material (for example, feed natural or associated gas), is supplied to the compressor inlet 9226 by the pipeline 9238. Downstream outlet from the compressor 9226 the gas mixture goes by a pipeline 9240 via the refrigerator 9268, the separator 9270, the filter 9272 installed in series and is introduced into the high-pressure chambers 9232 and 9254 of the first MGSU 9228 and additional MGSUs 9250 connected to it in parallel. The non-permeate above a membrane 9236 of the first MGSU 9228 through the membrane 9256 of additional MGSUs 9250 is directed to the HPCs 9232 and 9254 of the second MGSU 9230 and the additional MGSU 9252 by the pipeline 9242. The non-permeate from the HPCs 9232 and 9254 of the second MGSU 9230 and the additional MGSU 9252 with decreased content of impurities, for example, heavy hydrocarbons, water and carbon dioxide, is directed to the pipeline 9244 for supply to the consumer. The permeate with increased contents of impurities, for example, heavy hydrocarbons, water and carbon dioxide from the LPCs 9234 and 9256 of the first MGSU 9228 and the additional MGSUs 9250 under the membrane 9236 and 9258 is directed to utilization by the pipeline 9246. The permeate from the LPCs 9234 and 9256 of the second MGSU 9230 and the additional MGSUs 9252 is directed to the raw material supply pipeline 9238 by the pipeline 9248. Certain portion of the permeate is continuously removed from each of MGSUs 9228 and 9230 and in each of the additional MGSUs 9250 and 9252 by sweeping channels 9264 with the throttling elements from the HPCs 9232 and 9254 to the LPCs 9234 and 9256 of the relevant MGSU for sweeping, herewith the pressure is decreased in the LPCs 9234 and 9256 of the MGSUs 9228 and 9230 and additional MGSUs 9250 and 9252 by the vacuum compressors 9260 and 9262, installed in the pipeline 9246 and 9248, correspondingly. Sweeping of the LPCs 9234 and 9256 and decrease of pressure in them lead to increase of the gas separation efficiency. The capacity of the vacuum compressors 9260 and 9262 is chosen on condition of provision of maximum ratio of pressures at the membranes 9236 and 9258 of the MGSUs 9228 and 9230 and the additional MGSUs 9250 and 9252. The amount of sweep gas is chosen on the basis of provision of the maximum gas separation efficiency in the MGSUs 9228 and 9230 and the additional MGSUs 9250 and 9252.

The condensate flow from the separator 9270 by a pipeline 9286 of condensate removal is directed to the inlet 9276 of the condensate stabilization unit 9274, providing a possibility of condensate separation to the components. From the first outlet 9278 of the condensate stabilization unit 9274 by the pipeline 9288 the stabilized gas flow is deviated to the pipeline 9238 of the raw material supply. The gas mixture flow from the second outlet 9280 of the condensate stabilization unit 9274 by the pipeline 9290 is discharged to utilization. Stable hydrocarbon condensate from the third outlet 9282 is deviated to the further purification by the pipeline 9292, or is downhole injected, and the fourth outlet 9284 is used for the water condensate that may be used for downhole injection to maintain the formation pressure or for utilization, the water condensate is deviated by the pipeline 9294.

Herewith the provision of the plant with the additional membrane modules 9250 and 9252 and carrying out of sweeping in all MGSUs 9228, 9230, 9250 and 9252 of the LPCs 9234 and 9256 and simultaneous maintaining of the decreased pressure in them provide for the capacity increase and efficient separation of the gas mixture.

### EXAMPLE 13

### Purification of Natural and Associated High-Pressure Petroleum Gas at a Single-Stage Plant Wherein the Permeate Obtained From the First Stage is Purified at the Second Stage

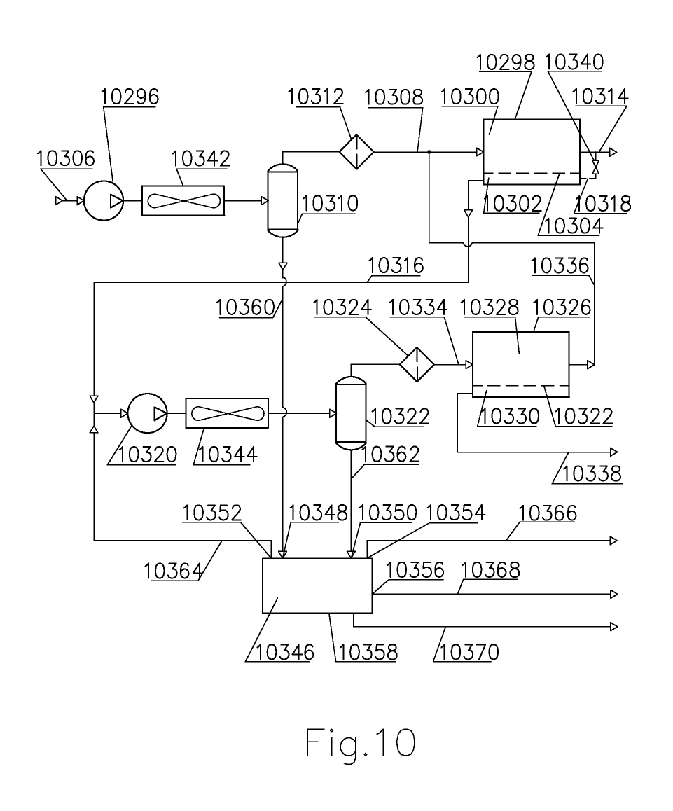

As shown at FIG. 10 the plant of the fuel gas purification from natural or associated petroleum gas comprises a compressor 10296 and a MGSU 10298 with high-and low-pressure chambers 10300 and 10302, separated by a SPM 10304, the compressor inlet 10296 is connected with a raw material supply pipeline 10306, and outlet is connected with a pipeline 10308 (via a separator 10310 and a filter 10312) with the HPC inlet 10300 of the MGSU 10298, outlet whereof is connected with a pipeline 10314 of the purified fuel gas to consumer, herewith the LPC 10302 of the MGSU 10298 is connected with a pipeline 10316, and the plant is equipped with a channel 10318 that provides for continuous supply of the portion of the non-permeate from the HPC 10300 of the MGSU 10298 to the LPC 10302 for sweeping and additionally with a compressor 10320, a separator 10322, a filter 10324 and a MGSU 10326 with high- and low-pressure chambers 10328 and 10330, separated by a membrane 10332, herewith inlet of the additional compressor 10320 is connected by a pipeline 10316, and outlet is connected by an additional high-pressure pipeline 10334 via the additional separator 10322 and a filter 10324 with the HPC 10328 inlet of the additional MGSU 10326. The HPC 10328 outlet of the additional MGSU 10326 is connected by a pipeline 10336 with the high-pressure gas mixture pipeline 10308 at the section between the filter 10312 and the MGSU 10298, and the LPC 10330 of the additional MGSU 10326 is connected to a pipeline 10338. The channel 10318 for sweeping may be equipped with a throttling element 10340, for example, an orifice. The channel 10318 for sweeping may be provided in the MGSU 10298 itself or by pipelines arrangement. The plant may be equipped with two refrigerators 10342 and 10344, the first refrigerator 10342 is installed in the high-pressure pipeline 10308 between the compressor 10296 and the separator 10310, and the second refrigerator 10344 is installed in the additional high-pressure pipeline 10334 between the additional compressor 10320 and the additional separator 10322. The plant can be also equipped with a condensate stabilization unit 10346 with two inlets 10348 and 10350 and four outlets 10352, 10354, 10356 and 10358, herewith the first inlet 10348 of the condensate stabilization unit 10346 is connected with condensate discharge pipeline 10360 from the separator 10310, and the second inlet 10350 is connected with a condensate takeoff pipeline 10362 from an additional separator 10332, herewith the first outlet 10352 of the condensate stabilization unit 10346 is interconnected with a pipeline 10364 and then connected with the feed gas stabilization supply pipeline 10316 for the re-processing, the second outlet 10354 is connected with pipeline 10366 of the gas mixture flow discharge to utilization, the third outlet 10356 is connected with a stabilized hydrocarbon condensate removal pipeline 10368 to further re-processing or to downhole injection, the fourth outlet 10358 is connected with a pipeline 10370 of the water condensate removal for downhole injection to maintain the formation pressure or to utilization.

The raw material (natural or associated petroleum gas) by the pipeline 10306 is supplied to the inlet of compressor 10296. From the compressor 10296 outlet the compressed gas by the pipeline 10308 via the refrigerator 10342, the separator 10310, the filter 10312 is directed to the LPC 10300 of the MGSU 10298. The gas mixture is preliminarily purified in the separator 10310 and the filter 10312 from the water and heavy hydrocarbons condensate and mechanical impurities. The gas mixture flow to the MGSU 10298 is divided into two flows: the non-permeate flow above the membrane 10304 and the permeate flow under the membrane 10304. The non-permeate flow above the membrane 10304 with low contents of water vapours and heavy hydrocarbons is directed by the pipeline 10314 to the consumer, herewith portion of the non-permeate is continuously deviated by the channel 10318 to the LPC 10302 for sweeping that increases gas separation efficiency in the MGSU 10298. The throttling element 10340, for example, an orifice provides for the removal of the certain non-permeate portion from the HPC 10300. From the LPC 10302 the gas mixture with increased contents of water vapours and heavy hydrocarbons by the pipeline 10316 is directed to the additional compressor 10320 inlet, that from one side compresses the gas mixture and from the other side decreases pressure in the LPC 10302 of the MGSU 10298, thus providing the necessary ratio of pressures at the membrane 10304, close to optimum value for efficient gas separation. The gas mixture from the additional compressor 10320 via the additional refrigerator 10344, the separator 10322 and the filter 10324 is supplied by the additional high-pressure pipeline 10334 to the LPC 10328 of the additional MGSU 10326, wherein the gas mixture is divided into two flows: the non-permeate flow above the membrane 10332 and the permeate flow under the membrane 10332. The non-permeate flow enriched with methane is deviated by the pipeline 10336 to the pipeline 10308 at its section between the filter 10312 and the MGSU 10298, and the permeate flow with large content of water vapours and low content of heavy hydrocarbons is deviated to utilization by the pipeline 10338.

If the plant is equipped with the gas stabilization unit 10346 from the separator 10310 and the additional separator 10322 the condensate is supplied by pipelines 10360 and 10362 to inlets 10348 and 10350. In the condensate stabilization unit 10346 the condensate is divided into four flows. From the first outlet 10352 of the condensate stabilization unit 10346 the stabilized gas flow is transported by the pipeline 10364 to the pipeline 10316. The flow of the gas mixture from the second outlet 10354 of the condensate stabilization unit 10346 by the pipeline 10366 is directed to utilization. The third outlet 10356 is dedicated to deviation of the stable hydrocarbon condensate to further re-processing or for downhole injection by the pipeline 10368, and the fourth outlet 10358 is dedicated to deviation of the water condensate that can be used for downhole injection to maintain the formation pressure or to the utilization by a pipeline 10370.

Sweeping of the LPC with the purified gas mixture allows to increase the gas separation efficiency and to decrease the purified gas loses.

### EXAMPLE 14

### Drying of Natural or Associated High-Pressure Petroleum Gas at a Two-Stage Plant Wherein the Discharge Flow From the First Stage is Purified at the Second Stage

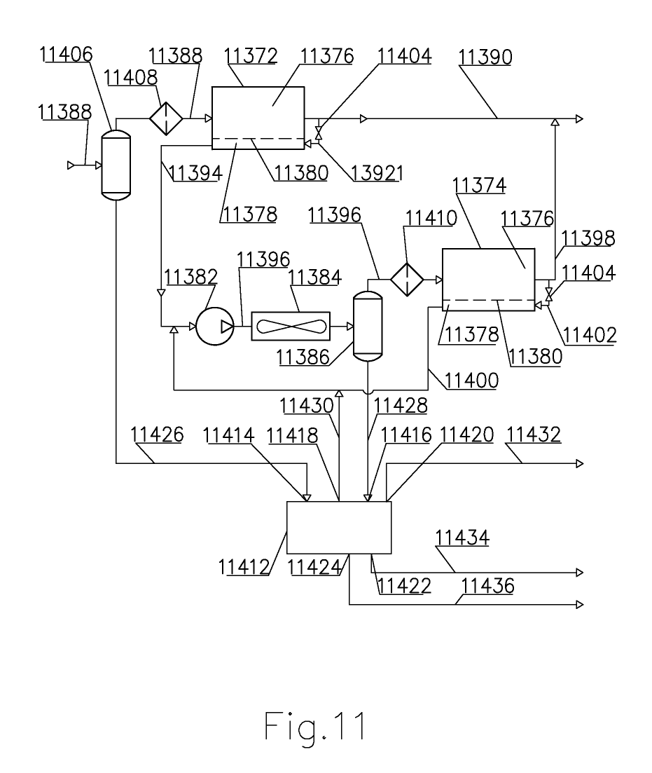

The plant for drying of natural gas comprises two MGSUs 1 1372 and 1 1374 with high- and low-pressure chambers 1 1376 and 1 1378, separated by a selectively permeable membrane 11380, a compressor 11382, a refrigerator 11384 and a separator 11386 as shown at FIG. 11. The inlet of the high-pressure chamber 11376 of the first MGSU 11372 is connected with a pipeline for raw material supply 11388, and outlet is connected with a pipeline 11390. The LPC 11378 inlet of the first MGSU 11372 is connected with the first channel 11392 of sweeping, and outlet is connected with the first pipeline 11394, connected to the compressor 11382 inlet, an outlet whereof is connected by a pressure pipeline 11396 (where a refrigerator 11384 and a separator 11386 are connected in series), with the HPC 11376 inlet of the second MGSU 11374, the outlet whereof is connected with a pipeline 11398. The low-pressure chamber 11378 of the second MGSU 11374 is connected by a pipeline 11400 with a pipeline 11394 and the second sweeping channel 11402, providing for the continuous supply of portion of the non-permeate from the second MGSU 11374 to the LPC 11378. The first channel 11392 for sweeping is designed with a possibility of provision of continuous supply of portion of the non-permeate from the first MGSU 11372 to the LPC 11378. The pipeline 11398 from the second MGSU 11374 is connected to the outlet pipeline 11390.

The channels 11392 and 11402 for sweeping have a throttling element 11404, for example an orifice.

The plant can be equipped with an additional separator 11406 and two filters 11408 and 11410, herewith the additional separator 11406 and the first filter 11408 are installed in series in the supply pipeline 11388, and the second filter 11410 is installed in the pressure pipeline 11396 between the separator 11386 and the second MGSU 11374.

The plant may be equipped with additional membrane modules (not shown at FIG. 11.), herewith at least one additional MGSU is connected in parallel to each of the membrane modules 11372 and 11374. The plant may be equipped with a condensate stabilization unit 11412, with two inlets 11414 and 11416 and four outlets 11418, 11420, 11422 and 11424, herewith each of inlets 11414 and 1 1416 of the condensate stabilization unit 1 1412 is connected with corresponding pipelines 1 1426 and 1 1428 of the condensate removal from the additional separator 1 1406 and the separator 1 1386, the first outlet 1 1418 of the condensate stabilization unit 1 1412 is connected to a gas stabilization flow supply pipeline 1 1430, connected to the pipeline 1 1400, the second outlet 1 1420 is connected to the pipeline 1 1432 of the gas mixture flow discharge to utilization, the third outlet 1 1422 is connected to the pipeline 1 1434 of the stable hydrocarbon condensate discharge to further re-processing or for downhole injection, the fourth outlet 1 1424 is connected with the pipeline 1 1436 of the water condensate discharge for downhole injection for maintaining of formation pressure or to utilization.

The raw material natural gas by the pipeline 1 1388 is supplied to the high-pressure chamber 1 1376 of the first MGSU 1 1372. The separator 1 1406 and the filter 1 1408, installed in the supply pipeline 1 1388 can be used for preliminarily drying of natural gas. Natural gas in the first MGSU 1 1372 at the membrane 1 1380 is divided into two flows i.e. to the permeate flow under the membrane 1 1380, and to the non-permeate; herewith the non-permeate contains no moisture in any significant amount. The non-permeate above the membrane 1 1380 from the HPC 1 1376 of the first MGSU 1 1372 is directed to the outlet pipeline 1 1390, whereof it is directed to the consumer. From the low-pressure chamber 1 1378 of the first MGSU 1 1372 the permeate with large contents of moisture is transported by the pipeline 1 1394 to the inlet of the compressor 1 1382, herewith the chamber 1 1378 is continuously swept with portion of the non-permeate from the first MGSU 1 1372, supplied by the channel 1 1392. From the outlet of the compressor 1 1382 the gas flow by the pipeline 1 1396 is directed to the refrigerator 1 1384 and then to the separator 1 1386, wherein the gas flow is stripped of moisture and condensate. Then the gas flow via the filter 1 1410 gets to the LPC 1 1376 of the second MGSU 1 1374. From the HPC 1 1376 of the second MGSU 1 1374 the non-permeate above the membrane 1 1380 is directed by the pipeline 1 1398 to the outlet pipeline 1 1390. The gas mixture with large contents of moisture is supplied by the pipeline 1 1400 to the pipeline 1 1394 from the LPC 1 1378 of the second MGSU 1 1374. The sweeping of the LPC 1 1378 of the second MGSU 1 1374 is accomplished by supply of the non-permeate from the second MGSU gas flow by the channel 1 1402. The throttling elements 1 1404, for example, orifices installed in the channels 1 1392 and 1 1402, provide for the necessary flow rate of gas flow to sweeping.

If the condensate stabilization unit 1 1412 is available the flows from the separators 1 1406 and 1 1386 are transported to inlets 1 1414 and 1 1416 by the pipelines 1 1426 and 1 1428 correspondingly. The gas stabilization flow from the outlet 1 1418 is directed by the pipeline 1 1430 to the pipeline 1 1400. The gas mixture flow from the pipeline outlet 1 1420 is directed to utilization by the pipeline 1 1432. The hydrocarbon condensate connected to the third outlet 1 1422 is deviated to the further processing or for downhole injection by the pipeline 1 1434, and the water condensate connected to the fourth outlet 1 1424 from the condensate stabilization unit 1 1412 is deviated by the pipeline 1 1436 for downhole injection for maintaining of the formation pressure or to utilization.

Sweeping of the LPC 1 1378 of the MGSU 1 1372 with drying the non-permeate flow from the first MGSU 1 1372 allowed to direct the gas flow dried in the second MGSU 1 1374 to the consumer that lead to increase of the plant capacity. Besides it gave an opportunity to carry out drying of the natural gas with higher content of the initial water and heavy hydrocarbons not only from water but also from heavy hydrocarbons.

### EXAMPLE 15

### Drying of High-Pressure Natural or Associated Petroleum Gas at a Two-Stage Plant Wherein the Discharge Flow From the First Stage is Purified at the Second Stage

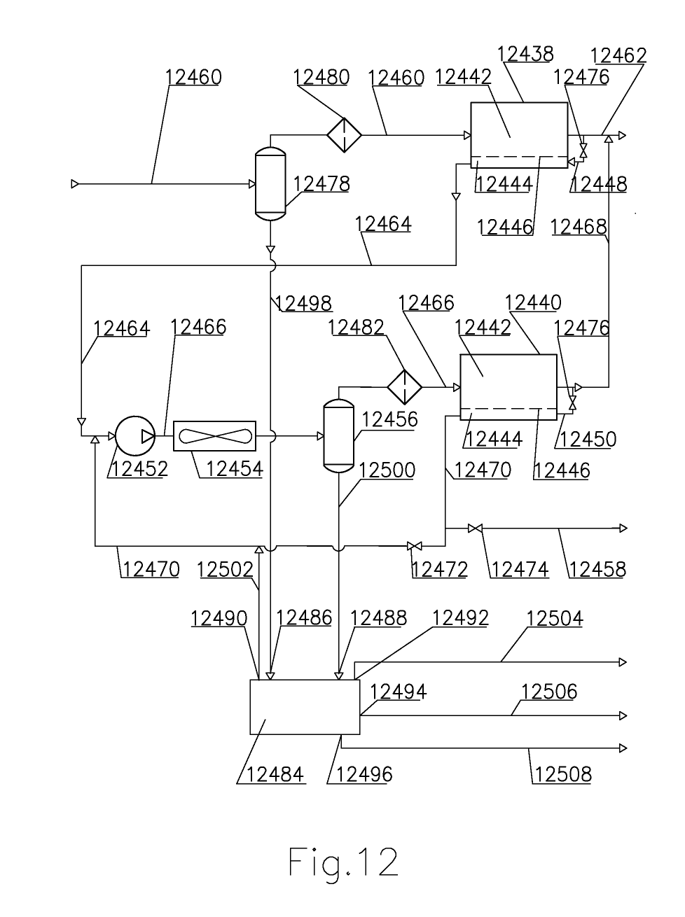

As shown at FIG. 12 the plant for drying of the natural gas comprises two MGSUs 12438 and 12440 with a HPC 12442 and a LPC 12444, separated by a SPM 12446, channels 12448 and 12450 of sweeping of the LPC 12444, a compressor 12452, a refrigerator 12454, a separator 124560 and a discharge pipeline 12458. Inlet of the HPC 12442 of the first MGSU 12438 is connected with a supply pipeline 12460, and the outlet is connected with an outlet pipeline 12462. The LPC 12444 inlet from the first MGSU 12438 is connected with the first sweeping channel 12448, and the outlet is connected with a pipeline 12464, connected to the compressor 12452 inlet. The compressor 12452 outlet is connected with a pressure pipeline 12466 (with the refrigerator 12454 and a separator 12456 installed in series) with the HPC 12442 inlet of the second MGSU 12440, the outlet whereof is connected to a pipeline 12468. The LPC 12444 of the second MGSU 12440 is connected by a pipeline 12470 with a pipeline 12464 and with the second channel 12450 for sweeping, providing continuous supply of portion of the non-permeate from the HPC of the second MGSU 12440. This plant is also equipped with two shut-off regulating devices 12472 and 12474, herewith the first shut-off regulating device 12472 was installed at the pipeline 12470, the second shut-off regulating device 12474 is installed at a discharge pipeline 12458, that is connected with the pipeline 12470 at the section between the first shut-off regulating device 12472 and the second MGSU 12440. The first sweeping channel 12448 provides for the possibility of continuous supply of some non-permeate from the first MGSU 12438 to the LPC 12444, and the pipeline 12468 from the second MGSU 12440 is connected to the outlet pipeline 12462.

The plant can comprise throttling elements 12476 in the sweeping channels 12448 and 12450 for example an orifice.

The plant can be equipped with an additional separator 12478 and two filters 12480 and 12482, herewith the additional separator 12478 and the first filter 12480 are installed in series in the supply pipeline 12460, and the second filter 12482 is installed in a pressure pipeline 12466 between the separator 12456 and the second MGSU 12440.

The plant can be equipped with additional membrane modules (not shown at FIG. 12), herewith at least one additional MGSU is installed in parallel to each of the membrane modules 12438 and 12440. The plant can be equipped with a condensate stabilization unit 12484, with two inlets 12486 and 12488 and four outlets 12490, 12492, 12494 and 12496, herewith each of inlets 12486 and 12488 of the condensate stabilization unit 12484 is connected to condensate withdrawal pipelines 12498 and 12500 from the relevant separators 12478 and 12482, the first outlet 12490 of the condensate stabilization unit 12484 is connected to a pipeline 12502 of the gas flow stabilization supply, connected by the pipeline 12470, the second outlet 12492 is connected to a pipeline 12504 of the gas mixture flow deviation to utilization, the third outlet 12494 is connected to a pipeline 12506 of stable hydrocarbon withdrawal for further re-processing or for the downhole injection, the fourth outlet 12496 is connected with the discharge pipeline 12508 of water condensate for downhole injection for maintaining of the formation pressure or to utilization.

The raw material natural gas is supplied to the high-pressure chamber 12442 of the first MGSU 12438 by the supply pipeline 12460. The separator 12478 and the filter 12480 installed in the supply pipeline 12460 can be used for preliminarily drying and purification of natural gas from mechanical impurities. Natural gas in the first MGSU 12438 is divided into two flows at the membrane 12446 i.e. to the permeate under the membrane 12446 and to the non-permeate, herewith the non-permeate does not contain any moisture in any significant amount. From the HPC 12442 of the first MGSU 12438 the non-permeate above the membrane 12446 is transported to the pipeline 12462 whereof it is directed to the consumer. The gas flow with large content of moisture from the LPC 12444 of the first MGSU 12438 is supplied by the pipeline 12464 to the compressor inlet 12452, herewith the chamber 12444 is swept by continuous supply of portion of the non-permeate from the first MGSU 12438 by the channel 124486. From the compressor outlet 12452 gas flow by the pressure pipeline 12466 is directed to the refrigerator 12454 and then to the separator 12456 wherein moisture is removed from the gas flow. Then gas flow via the filter 12482 goes to the HPC 12442 of the second MGSU 12440. The non-permeate above the membrane 12446 from the HPC 12442 of the second MGSU 12440 is directed by the pipeline 12468 to the outlet pipeline 12462. The permeate with large content of moisture from the LPC 12444 of the second MGSU 12440 is supplied by the second pipeline 12470 by the open the shut-off regulating device 12472 to the pipeline 12464, herewith the shut-off regulating device 12474, installed in the discharge pipeline 12458, is closed. In case of decreasing of the quality of the drying natural gas due to excess of moisture in the permeate from the second MGSU 12440, it is periodically discharged by the pipeline 12458, herewith the shut-off regulating device 12472 is to be closed for a short period and the shut-off regulating device 12474 is to be open. Thus the moisture content in the permeate from the MGSU 12440 is decreased. The sweeping of the LPC 12444 of the second MGSU 12440 is accomplished by supply of portion of the non-permeate from the second MGSU 12440 by the channel 12450. The throttling elements 12476, for example, orifices, installed in the channels 12448 and 12450, provide for necessary flow rate of the sweep gas.

If the condensate stabilization unit 12484 is available, condensate is supplied by the pipelines 12498 and 12500 from the separators 12478 and 12456 to its inlets 12486 and 12488. Stabilized gas is directed from the outlet 12490 by the pipeline 12502 to the pipeline 12470. The gas mixture is directed to utilization from the outlet 12492 by the pipeline 12504. Stable hydrocarbon condensate is taken off by the pipeline 12506 connected to the third outlet 12494 for the further reprocessing or downhole injection, and by a pipeline 12508, connected to the fourth outlet 12496, water condensate is deviated from the condensate stabilization unit 12484 for downhole injection for maintaining formation pressure or to utilization.

Sweeping of the LPC 12444 of the MGSU 12438 with the dried non-permeate from the HPC of the MGSU 12438, and provision of possibility of periodical discharge of non-specification gas flow from the low-pressure pipeline 12470 allowed to direct gas flow dried at the second MGSU 12440 also to the outlet pipeline to the consumer that lead to increase of efficiency of gas drying in the plant. Besides, it provided a possibility to carry out drying of gases mixture not only from water but also from heavy hydrocarbons, herewith the dried gas mixture can have higher content of the initial water and heavy hydrocarbons.

What is claimed is:

1. A method of purification of a high-pressure hydrocarbon gas mixture (HPGM) comprising hard permeating components and easily permeating components through a membrane, the method comprising:
supplying said gas mixture to a plant comprising at least one membrane gas separating unit (MGSU) comprising a high-pressure chamber (HPC), a low-pressure chamber (LPC) and a selectively permeable membrane (SPM) therebetween;
continuously venting the low-pressure chamber (LPC) of at least one membrane gas separating unit (MGSU) with the gas mixture from the high-pressure chamber (HPC);
purifying the high-pressure hydrocarbon gas mixture of one or more of the easily permeating components selected from the group consisting of water vapor, acid gases, heavy hydrocarbons, merkaptans, and helium;
selecting a portion of a purified gas mixture to be used in the venting of the low-pressure chamber (LPC) in such a way that the portion composes from about 2% to about 25% of the hydrocarbon gas mixture, and a ratio of a pressure in the high-pressure chamber (HPC) to a pressure in the low-pressure chamber (LPC) is lower than a ratio of a specific permeability of the selectively permeable membrane (SPM) for each separated easily permeating component to a specific permeability of the permeable membrane (SPM) for a main hard permeating component or all hard permeating components.

2. The method per claim 1, wherein purifying the high-pressure hydrocarbon gas mixture occurs at a plant comprising at least two MGSUs and wherein the gas mixture from the LPC outlet of one of the MGSU is introduced to the HPC inlet of another MGSU.

3. The method per claim 1, wherein purifying the high-pressure hydrocarbon gas mixture occurs at a plant comprising two MGSUs herewith the HPGM is supplied to the HPC of the first MGSU, gas mixture from the HPC of the first MGSU is supplied to the HPC of the second MGSU, the gas mixture from the LPC outlet of the second MGSU is directed to the HPC inlet of the first MGSU.

4. The method per claim 1, characterized in that the gas mixture is purified by a plant comprising several MGSUs wherein the gas mixture from the LPC outlet of the first MGSU is directed to the HPC inlet of the second MGSU and/or to the HPC inlet of the consequent MGSUs.

5. The method per claim 1, characterized in that the gas mixtures supplied to the HPC inlet are preliminarily compressed.

6. The method per claim 1, characterized in that the gas mixtures supplied to the HPC inlet are preliminarily cooled.

7. The method per claim 1 characterized in that the gas mixtures supplied to the HPC inlet are preliminarily separated.

8. The method per claim 1 characterized in that the gas mixtures supplied to the HPC inlet are preliminarily filtrated.

9. The method per claim 1, characterized in that the gas mixtures supplied to the HPC inlet are preliminarily heated.

10. The method per any of claim 1 characterized in that the pressure is decreased in the LPC of the first and the succeeding MGSUs ,

11. The method per claim 10, characterized in that the pressure in the LPC of at least one MGSU is maintained below the atmosphere pressure.

12. A plant for purification of high-pressure hydrocarbon gas mixture (HPGM), comprising components hard permeating and easily permeating through a membrane comprising: at least one membrane gas separating unit (MGSU) with a high-pressure chamber (HPC), a low pressure chamber (LPC) and a selectively permeable hollow fiber membrane (SPM) therebetween, herewith the indicated chambers are equipped with a throttling device for direction of the portion of purified gas mixture flow from the HPC to sweeping of the LPC characterized in that the plant is equipped with the gas mixture flow rate and pressure regulation device in the LPC connected with the LPC of at least one of the MGSUs with intention to maintain the ratio of pressure in the HPC to the pressure in the LPC lower than the ratio of the specific permeabilities of the SPM per each easily permeating component, from which purification is accomplished, to the specific permeability of the SPM per the main or all hard permeating components.

13. The plant per claim 12, characterized in that it comprises at least two MGSUs, herewith the LPC of at least one of the tail MGSUs is connected with the inlet of the HPC of at least one of the head MGSUs preferably with the inlet of the first MGSU.

14. The plant per claim 12, characterized in that inlets and outlets of at least two MGSUs are connected with each other in parallel.

15. The plant per claim 12 characterized in that the LPC of at least one MGSU is equipped with means of pressure decrease including till the pressure below the atmosphere pressure.

16. The plant per claim 15, characterized in that a vacuum compressor is used as a means for pressure decrease.

17. The plant per claim 12, characterized in that the inlet of the HPC of at least one of the MGSU is connected with the LPC outlet of at least one other MGSU via a compressor.

18. The plant per claims 12, characterized in that the HPC inlet of at least one of the MGSU is connected with the LPC outlet of at least another MGSU via a refrigerator.

19. The plant per claims 12, characterized in that the HPC inlet of at least one of the MGSUs is connected with the LPC outlet of at least another MGSU via a separator.

20. The plant per claims 12, characterized in that the HPC inlet of at least one of MGSUs is connected with the LPC outlet of at least another MGSU via a filter.

21. The plant per claim 12, characterized in that the HPC inlet of at least one of the MGSUs is connected with the LPC outlet of at least another MGSU via a heater.

22. The plant per claim 19, characterized in that it is equipped with a condensate stabilization unit with outlets for stabilized gas, discharge gas, water condensate and stabilized hydrocarbon condensate.

23. The plant per claim 22, characterized in that the stabilization unit outlet for the stabilized gas is connected with the HPC inlet of at least one MGSU.
